(19) United States
(12) Patent Application Publication
(10) Pub. No.: US 2006/0126348 A1
(43) Pub. Date: Jun. 15, 2006

(54) Decorative lamp

(76) Inventor: Steve Lee, Park Ridge, IL (US)

Correspondence Address: Pauley Petersen & Erickson, Suite 365, 2800 West Higgins Road, Hoffman Estates, IL, 60195, US

(21) Appl. No.: 11/139,054

(22) Filed: May 27, 2005

Related U.S. Application Data
(63) Continuation-in-part of application No. 11/011,665, filed on Dec. 14, 2004.

(51) Int. Cl. F21V 15/04

(52) U.S. Cl. 362/390

(57) ABSTRACT

A decorative lamp including a base. At least one bendable spring element is connected with respect to the base. The spring element is bendable and/or positionable into a configured shape and retains the configured shape, as desired. A socket is connected to the spring element and accepts a light bulb. A wire extends through a central void formed along a length of the spring element to operatively connect the socket to an electrical source. The decorative lamp includes a lampshade mountable with respect to the socket. The decorative lamp may also include a vibrator connectable with respect to the base and/or the spring element and imparting motion to the spring element.

### CROSS REFERENCE TO RELATED APPLICATION(S)

This application is a continuation-in-part application of application, U.S. Ser. No. 11/011,665, filed on 14 Dec. 2004. The co-pending parent application is hereby incorporated by reference herein and is made a part hereof, including but not limited to those portions which specifically appear hereinafter.

### BACKGROUND OF THE INVENTION

1. Field of the Invention

This invention relates to a decorative lamp including at least one spring element on which a bulb and lampshade are mounted.

2. Description of Related Art

Lamps generally include a base and a static neck and shade. Reading lamps may include a hinged, cantilevered neck for placement of the light source in a desired location. In addition, flashlights having articulating and flexible stems are available for directing and fixing a light source in a desired location.

### SUMMARY OF THE INVENTION

In one preferred embodiment of this invention, a decorative lamp preferably includes a base at one end portion and a socket at an opposite end portion. The socket accommodates or accepts a suitable light bulb, such as a standard incandescent light bulb.

The decorative lamp according to this invention further includes one or more mounts that extend between the base and the socket. Each mount includes a bendable spring element made of a suitable bendable or flexible material, such as a bendable metal material, that retains its shape after bending or flexing. The spring element is preferably bendable and/or positionable in any number of configured shapes and/or positions and remains in the configured shape and/or position, as desired. In one preferred embodiment of this invention, each spring element is connected with respect to one end portion of the base and includes an opposite end portion attached or connected to a corresponding socket.

Additionally, a decorative lampshade may be attached with respect to the socket and may include one or more moveable elements that respond to a vibrating or oscillating motion imparted from the spring element. In one preferred embodiment of this invention, a vibrator may be connected with respect to the decorative lamp to impart a vibrating motion to at least one of the spring elements. As a result, the decorative lampshade moves during operation of the vibrator.

The decorative lamp may further include multiple bendable spring elements and corresponding sockets extending from the base. This configuration results in multiple light sources having articulating mounts.

Other objects and advantages of this invention are apparent to those skilled in the art, in view of the following detailed description taken in conjunction with the appended claims and drawings.

### BRIEF DESCRIPTION OF THE DRAWINGS

The drawings show a decorative lamp, according to preferred embodiments of this invention, wherein:

FIG. 1 is a front perspective view of a decorative lamp, according to one preferred embodiment of this invention;

FIG. 2 is a front perspective view of a decorative lamp with a decorative lampshade removed from one mount, according to one preferred embodiment of this invention;

FIG. 3 is a front perspective view of a portion of the decorative lamp shown in FIG. 2;

FIG. 4 is a front perspective view of a decorative lamp, according to one preferred embodiment of this invention; and

FIG. 5 is a front view of a portion of a decorative lamp, according to one preferred embodiment of this invention.

### DESCRIPTION OF THE PREFERRED EMBODIMENTS

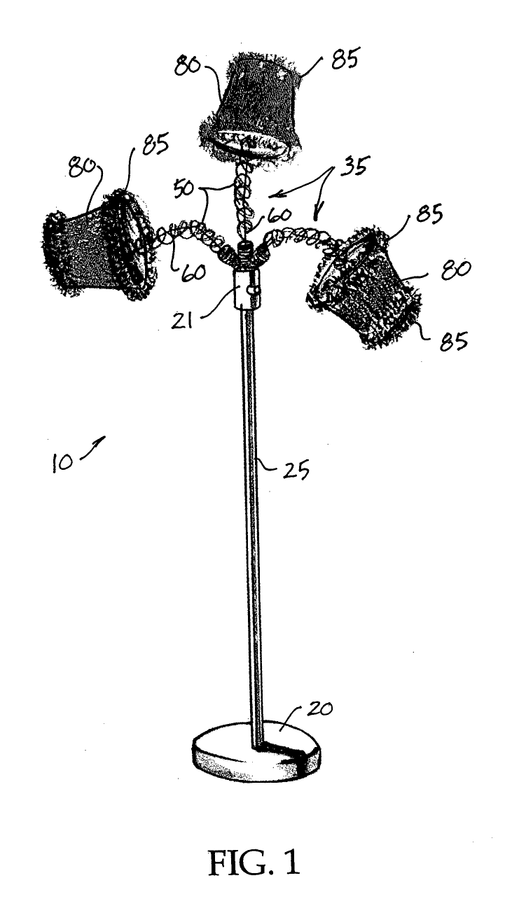

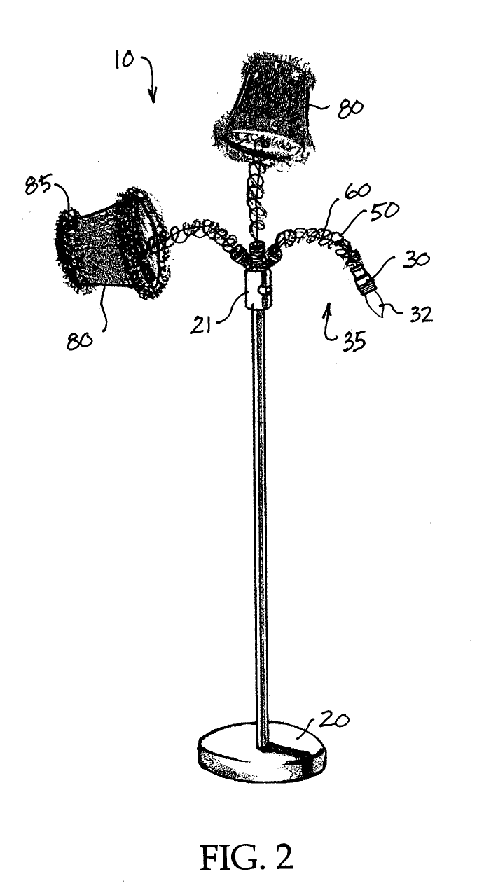

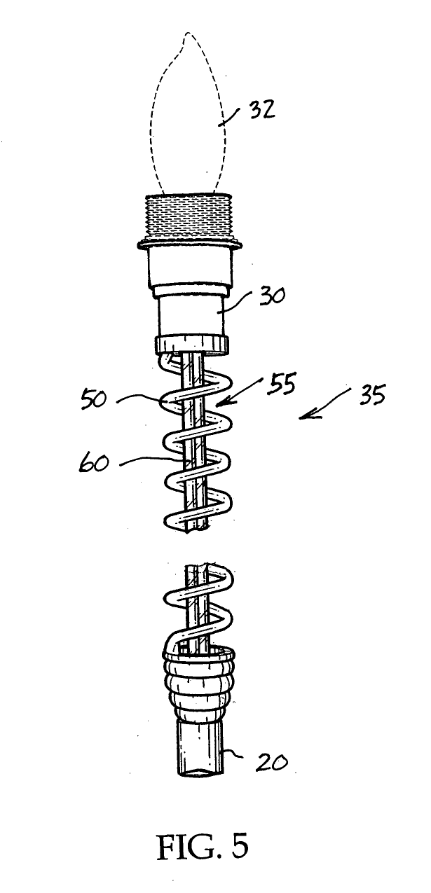

FIGS. 1-5 show various views and embodiments of a decorative lamp 10 according to preferred embodiments of this invention. As shown in FIG. 2, decorative lamp 10 preferably includes a base 20 and at least one socket 30. Socket 30 preferably accommodates or accepts any suitable light bulb, such as a standard incandescent light bulb.

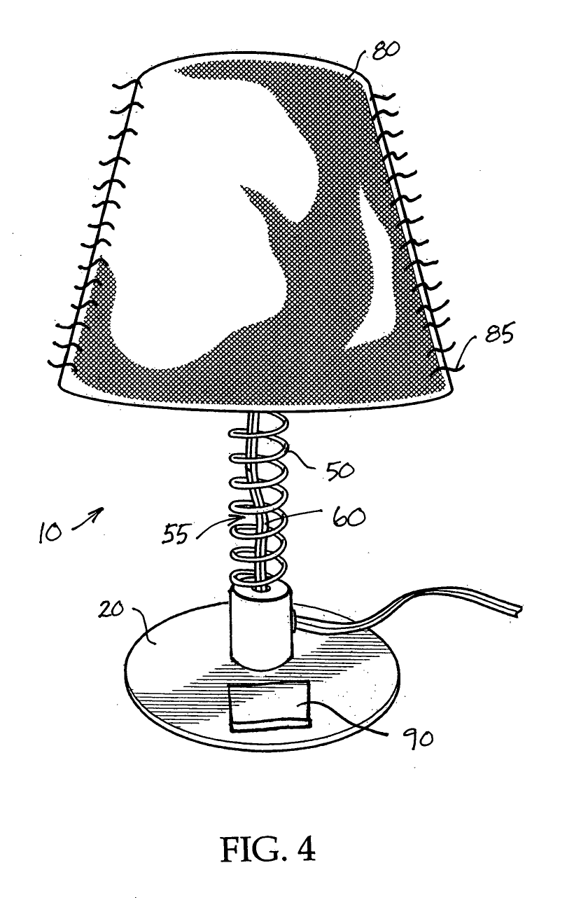

In one preferred embodiment of this invention, an extension member 25 is connectable, such as threadedly connectable, to base 20 to form or construct a floor lamp, such as shown in FIGS. 1 and 2. Alternatively, in the case of a table lamp such as shown in FIG. 4, base 20 may transition directly into at least one bendable and/or positionable spring element 50, as described in more detail below. Decorative lamp 10 may be largely constructed of a metal, a composite, a plastic and/or any other suitable material known to those having ordinary skill in the art.

In one preferred embodiment of this invention, decorative lamp 10 includes one or more mounts 35 that extend between base 20 and socket 30. Mount 35 includes a flexible, bendable and/or positionable spring element 50. Spring element 50 extends, either directly or indirectly, from base 20 and is preferably formed of a suitable bendable metal material or any other suitable material that is flexible and/or bendable. As a result, each spring element 50 is bendable and/or positionable in any number of configured shapes and/or positions, as desired. Spring element 50 preferably retains the desired configured shape until the user decides to change or alter the configured shape by bending and/or positioning spring element 50 into a newly desired configured shape.

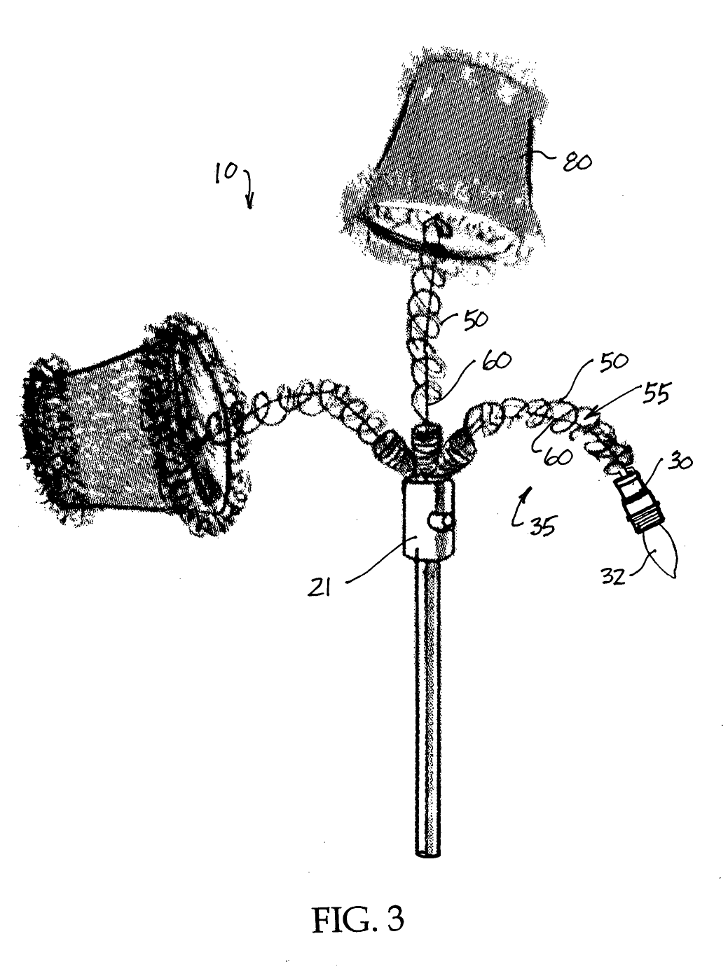

Spring element 50 is preferably, but not necessarily, connected with respect to an end portion 21 of base 20. Preferably, spring element 50 is fixed at a first end portion to base 20 and includes an opposite second end portion attached or connected to a corresponding socket 30. As a result of this configuration, spring element 50 is freely moveable with respect to end portion 21. In one preferred embodiment of this invention, spring element 50 is made of a helically wound metal material forming loosely wound coils resulting in a loose spring that is responsive to even gentle stimuli. In addition, spring element 50 is preferably sufficiently rigid to support socket 30 and lampshade 80. As shown in FIGS. 3-5, spring element 50 includes or forms a central void 55 along at least a portion of a length of spring element 50.

A wire 60 suitable for supplying an electric current to socket 30 extends through central void 55 formed by spring element 50 and operatively connects socket 30 to an electrical source. For example, wire 60 provides electric power from a standard wall outlet to socket 30 and a bulb 32 positioned within socket 30. Wire 60 is preferably positioned within central void 55 and stretched taut so as to not interfere with the free movement of spring element 50. In addition, wire 60 is preferably visible between the coils of spring element 50, as shown in FIGS. 1-5.

Decorative lampshade 80 may be attached with respect to socket 30. Decorative lampshade 80 may include one or more moveable elements 85 that respond to a vibrating motion. For example, a plurality of feathers may be attached with respect to decorative lampshade 80 to enhance or accentuate an oscillating and/or vibrating motion created by spring element 50 and/or vibrator 90, as discussed below. Such moveable elements 85 thereby respond and/or react to movement of decorative lampshade 80 and/or movement of mount 35 relative or with respect to base 20.

In one preferred embodiment of this invention, vibrator 90 may be connected with respect to base 20, at least one mount 35, at least one spring element 50 and/or at least one socket 30. Vibrator 90 preferably imparts a vibrating motion to each mount 35 and/or spring element 50 whereby each mount and/or each spring element 50 moves or oscillates relative to base 20. As shown in FIG. 4, in one preferred embodiment of this invention, vibrator 90 is mounted or connected to base 20 and, when activated, imparts motion to spring element 50. As a result, decorative lampshade 80 moves during operation of vibrator 90. Alternatively, vibrator 90 may be connected with respect to spring element 50 to impart motion to spring element 50 and corresponding socket 30.

As shown in FIGS. 1-3, decorative lamp 10 may include a plurality of bendable spring elements 50 and corresponding sockets 30 extending either directly from base 20 or from extension member 25 of base 20. More specifically, a trio of bendable spring elements 50 may extend from extension member 25, as shown in FIGS. 1-3, or from base 20.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A decorative lamp comprising:
a base;
a bendable spring element connected with respect to a first end portion of the base, the spring element bendable into a configured shape and retaining the configured shape;
a socket connected to the spring element and accepting a light bulb; and
a wire extending through the spring element through a central void formed along a length of the spring element, the wire operatively connecting the socket to an electrical source.

2. The decorative lamp of claim 1 further comprising:
a decorative lampshade mounted with respect to the socket.

3. The decorative lamp of claim 1 further comprising:
a vibrator connected to the base, the vibrator imparting motion to the spring element.

4. The decorative lamp of claim 1 further comprising:
a vibrator connected with respect to the spring element, the vibrator imparting motion to the spring element.

5. The decorative lamp of claim 4 further comprising:
a decorative lampshade connected with respect to the socket, the decorative lampshade having at least one moveable element that responds to the motion.

6. The decorative lamp of claim 1 further comprising:
a plurality of bendable spring elements and corresponding sockets extending from the base.

7. The decorative lamp of claim 1 further comprising:
a trio of bendable spring elements extending from the first end portion of the base; and
a socket connect to each spring element.

8. A decorative lamp comprising:
a base;
at least one bendable spring element connected with respect to a first end portion of the base, the at least one spring element positionable in a configured shape and retaining the configured shape;
a socket connected to the at least one spring element and accepting a light bulb;
a wire extending through the at least one bendable spring element through a central void formed along a length of the at least one spring element, the wire connecting the socket to an electrical source; and
a vibrator connected with respect to at least one of the base, the at least one spring element and the socket, the vibrator imparting a vibrating motion to the at least one bendable spring element.

9. The decorative lamp of claim 8 further comprising:
a decorative lampshade connected with respect to the socket, the decorative lampshade having at least one moveable element that responds to the vibrating motion.

10. The decorative lamp of claim 8 further comprising:
a plurality of bendable spring elements extending from the base, each bendable spring element positioned in a configured shape and retaining the configured shape.

11. The decorative lamp of claim 8 further comprising:
a plurality of bendable spring elements extending from the base; and
a socket connected to each bendable spring element.

12. The decorative lamp of claim 8 wherein the base includes an extension member.

13. A decorative lamp comprising:
a base; and
a plurality of mounts, each mount of the plurality of mounts connecting a socket to the base, each mount including a bendable spring element extending from the base and bendable in a retainable configured shape, and a wire extending from the base and through the bendable spring element to connect the socket to an electrical source.

14. The decorative lamp of claim 13 further comprising:
a vibrator connected to the base, the vibrator vibrating the plurality of mounts whereby each mount moves relative to the base.

15. The decorative lamp of claim 14 further comprising:
a lampshade positioned around the socket, the lampshade having a plurality of moveable elements that respond to the motion of the mount.
